(19) United States
(12) Patent Application Publication
(10) Pub. No.: US 2011/0025862 A1
(43) Pub. Date: Feb. 3, 2011

(54) PAN AND TILT HEAD FOR OPTICAL APPARATUS

(75) Inventor: Richard Arthur Lindsay, Surrey (GB)

Correspondence Address: FELLERS SNIDER BLANKENSHIP;BAILEY & TIPPENS, THE KENNEDY BUILDING, 321 SOUTH BOSTON SUITE 800, TULSA, OK, 74103-3318, US

(73) Assignee: THE VITEC GROUP PLC, Kingston Upon Thames, SURREY (GB)

(21) Appl. No.: 12/937,368

(22) PCT Filed: Apr. 9, 2009
(86) PCT No.: PCT/GB2009/000939

§ 371 Date: Oct. 11, 2010

(30) Foreign Application Priority Data
Apr. 11, 2008 (GB) 0806663.1

(51) Int. Cl. H04N 5/217

(52) U.S. Cl. 348/208.5; 348/208.7; 348/E05.031

(57) ABSTRACT

The disclosure relates to a pan and tilt head (12) for an optical apparatus (10) (e.g. a video camera) which captures or creates an image. The head has a base (19) to be mounted on a support structure (11) (e.g. a tripod), and a body (15) is mounted on the base for pan movement and a platform mounted on the body for tilt movement, about a tilt axis to receive the optical apparatus. The head includes damping means for damping both pan and tilt movement and transducer means (17, 20) for measuring tilt movement of the body about said tilt axis and pan movement of the base to provide measures of unwanted pan and tilt movement for correction of the optical apparatus for said unwanted movement.

This invention relates to pan and tilt heads for mounting optical apparatus and is particularly although not exclusively applicable to pan and tilt heads for cameras such as TV, video or cinematograph cameras, light beam directing devices and sighting devices.

Our International Patent Publication No. WO 00/39498 discloses a mounting for an optical apparatus having an optical axis, the head having non-moving and moving components including a base and a support for the optical apparatus which provide movement about one or more axes (e.g. pan and tilt axes) and having damping means between the moving and non-moving components in each axis. Encoders are provided for measuring the movement between the moving and non-moving components across the damping means in each axis to indicate the intended movement of the support in each axis and a gyroscope is provided for measuring the actual movement of the support in the or each axis. The difference between the actual and intended movements of the support is determined representing the unwanted movement and a correction is applied to the support/apparatus to counter the unwanted movement.

Providing encoders across the damping means in the pan and tilt head requires a non-standard head increasing the costs. An object of this invention is to provide a pan and tilt head in which unwanted movement between the moving and non-moving components of the head in each axis can be determined without the need for encoders for measuring movement of the moving components with respect to the non-moving components in each axis.

This invention provides a pan and tilt head for an optical apparatus which captures or creates an image, the head having a base to be mounted on a support structure, a body mounted on the base for pan movement and a platform mounted on the body for tilt movement about a tilt axis to receive an optical apparatus, the head including damping means for damping both pan and tilt movement and transducer means for measuring tilt movement of the body about said tilt axis and pan movement of the base to provide measures of unwanted pan and tilt movement for correction of the optical apparatus for said unwanted movement.

Preferably, the transducer means comprise one transducer mounted on the base of the head to measure unwanted pan movement of the base and a second transducer mounted on the body of the head for measuring unwanted tilt movement of the head about said tilt axis.

In either of the above arrangements the transducers may be selected from electronic gyroscopes, inclinometers or accelerometers.

In any of the above arrangements the optical apparatus may be a TV/video camera.

In the latter case, a control system is provided in communication with the transducer means for generating correction signals and having an output for connection to means for adjusting one of the camera, the camera mounting, the camera optics, image capture, image replay or post image processing for applying corrections thereto for said unwanted movement.

The following is a description of a specific embodiment of the invention, reference being made to the accompanying drawings in which:

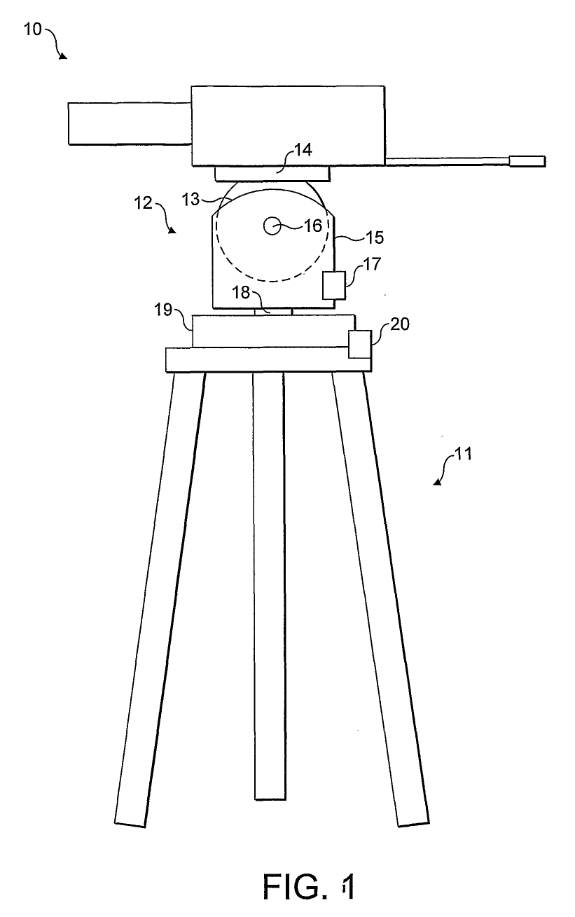

FIG. 1 is a diagrammatic illustration of a pan and tilt head embodying the present invention the head being located on a standard tripod and carrying a video camera;

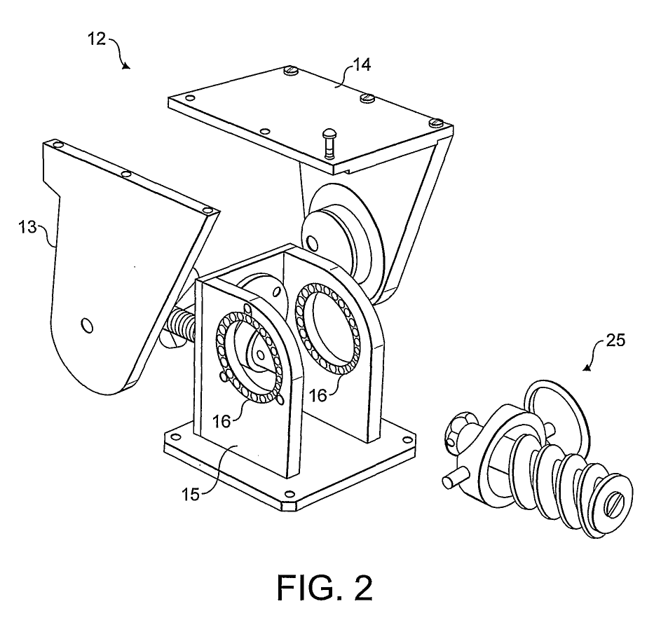

FIG. 2 is an exploded perspective view of a known form of mechanism for counterbalancing tilt movement including the camera in the head; and

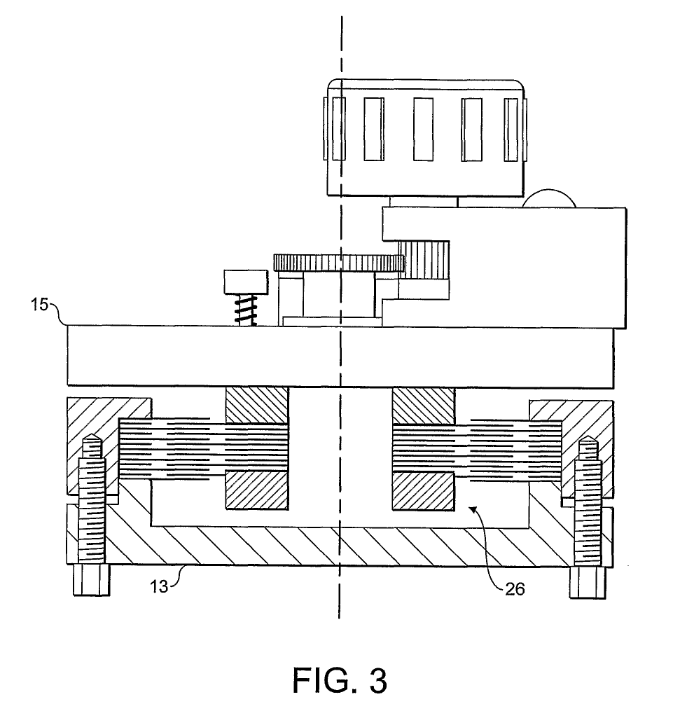

FIG. 3 shows a known form of adjustable damper suitable for use in damping movement between the moving and non-moving parts of the head in both pan and tilt axes.

Referring first to FIG. 1 of the drawings, a video camera is indicated generally at 10 mounted on a tripod indicated at 11 by means of a pan and tilt head indicated at 12.

The pan and tilt head has a tilting section 13 having a platform 14 to receive the camera 10. The tilting section 13 is supported on a body 15 in bearings 16 and a counterbalancing mechanism is incorporated in the head to counterbalance the tilting section and camera in any position to which the camera is moved. FIG. 2 of the drawings shows a suitable counterbalancing mechanism indicated at 25. The mechanism is fully described in our UK Patent Publication No. 2189042 to which reference should be made.

A rotary adjustable damper 26 is provided between the tiltable section and body to damp movement of the tilting section with respect to the body. A suitable form of damper is shown in FIG. 3 of the drawings. The damper is fully described in our European Patent Publication No. 0850382 to which reference should be made.

The body 15 has a transducer in the form of an electronic gyroscope 17 to detect tilt movement of the body 15 about the axis of the bearings 16. Any tilt movement detected in the body 15 is unwanted movement and the information provided by the gyroscope is fed to a control system (not shown) for correcting the camera mounting, camera optics, or image capture or image replay to counter the unwanted tilt movement.

The body 15 is supported for rotation about a vertical axis in a bearing 18 located on a fixed base 19. A similar damper to damper 26 is provided for damping pan movement of the body 15 in the bearing about the base 19.

An electronic gyroscope 20 is mounted on the base for determining pan movement in the base. Any pan movement in the base will represent unwanted movement which needs to be corrected. The signals from the gyroscope 20 are fed to a controller which provides corresponding correction signals to appropriate actuators for one of the camera, the camera mounting, the camera optics, image capture, image replay, or for post image processing. Reference should be made to our UK Patent Publication Nos. 2359743, 2425907 and 2442602 and International Patent Publication No. WO 2006/117568 for details of suitable arrangements.

It will be appreciated that the electronic gyroscopes referred to above could take the form of any suitable transducer for detecting movement including accelerometers and inclinometers (in the case of tilt movement).

In further embodiments of the invention the optical apparatus may be a device for directing a light beam (e.g. laser light) or a sighting device. In such arrangements a control system is provided in communication with the transducer means for generating correction signals and having an output in communication with an adjustable feature of the optical apparatus to correct for said unwanted movement.

The apparatus may also embody a homing device for reducing any offset in the arrangement for countering unwanted movement to zero. The homing device may be rendered inoperable when the apparatus or image are not moving for example by image analysis or manual selection. Such arrangements are described in greater detail in our UK Patent Application No. 0806871.0.

1. A pan and tilt head (12) for an optical apparatus (10) which captures or creates an image, the pan and tilt head having a base (19), a body (12) mounted on the base for pan movement and a platform (14) to receive an optical apparatus mounted on the body for tilt movement about a tilt axis, the head including one damping means for damping pan movement of the body with respect to the base and a second damping means for damping tilt movement of the platform with respect to the body, and transducer means (17, 20) for determining pan and tilt movement in the pan and tilt head to provide measures of unwanted pan and tilt movement for correction of the optical apparatus for said unwanted movement.

2. The pan and tilt head as claimed in claim 1, wherein said transducer means is selected from a group consisting of gyroscopes, inclinometers and accelerometers.

3. The pan and tilt head as claimed in claim 1 wherein the optical apparatus is a TV/video camera (10).

4. The pan and tilt head as claimed in claim 3, further comprising a control system in communication with said transducer means for generating correction signals and having an output for connection to means for adjusting said TV/video camera, mounting for said TV/video, optics for said TV/video camera, image capture, image replay or post image processing for applying corrections thereto for said unwanted movement.

5. The pan and tilt head as claimed in claim 1 wherein the optical apparatus comprises a light beam directing device or a sighting device.

6. A pan and tilt head as claimed in claim 5, further comprising a control system in communication with the transducer means for generating correction signals and having an output for communication with an adjustable feature of the optical apparatus to correct the said unwanted movement.

7. The pan and tilt head of claim 1 wherein said transducer means comprises a first transducer (17) provided in said body for measuring tilt movement of the body (12) about said tilt axis and a second transducer (17) provided in said base for measuring pan movement of the base (19).

8. A pan and tilt head (12) for an optical apparatus (10) which captures or creates an image, the pan and tilt head comprising a base (19) capable of mounting on a support structure (11), a body (12) mounted on the base for pan movement and a platform (14) to receive the optical apparatus mounted on the body for tilt movement about a tilt axis, the pan and tilt head including a first damper for damping pan movement of the body with respect to the base and a second damper for damping tilt movement of the platform with respect to the body, and at least one transducer (17) for determining pan and tilt movement in the pan and tilt head to provide measures of unwanted pan and tilt movement for correction of the optical apparatus for said unwanted movement.

9. The pan and tilt head of claim 1 wherein at least one transducer is selected from a group consisting of gyroscopes, inclinometers and accelerometers.

10. The pan and tilt head of claim 9 wherein the optical apparatus is a TV/video camera (10).

11. The pan and tilt head of claim 10, further comprising a control system in communication with said at least one transducer for generating correction signals and having an output for connection to means for adjusting said TV/video camera, mounting for said TV/video camera, optics for said TV/video camera, image capture, image replay or post image processing for applying corrections thereto for said unwanted movement.

12. The pan and tilt head of claim 9 wherein said optical apparatus comprises a light beam directing device or a sighting device and further comprises a control system in communication with said at least one transducer for generating correction signals and having an output for communication with an adjustable feature of said optical apparatus to correct the said unwanted movement.

13. The pan and tilt head of claim 8 wherein said at least one transducer comprises a first transducer (17) for measuring tilt movement of said body (12) about said tilt axis and a second transducer (20) for measuring pan movement of said base (19).

14. The pan and tilt head of claim 13 wherein said first transducer is provided in said body and said second transducer is provided in said base.

15. A pan and tilt head (12) for an optical apparatus (10) which captures or creates an image, the pan and tilt head having a base (19), a body (12) mounted on said base for pan movement and a platform (14) capable of receiving an optical apparatus mounted on the body for tilt movement about a tilt axis, the pan and tilt head including a first damper for damping pan movement of the body with respect to the base and a second damper for damping tilt movement of the platform with respect to the body, a first transducer (17) for measuring tilt movement of the body (12) about said tilt axis and a second transducer (17) for measuring pan movement of the base (19) said first transducer and said second transducer to provide measures of unwanted pan and tilt movement for correction of the optical apparatus for said unwanted movement.

16. The pan and tilt head of claim 15, wherein said first transducer and said second transducer (17) are selected from a group consisting of gyroscopes, inclinometers and accelerometers.

17. The pan and tilt head of claim 15 wherein the optical apparatus is a TV/video camera (10).

18. The pan and tilt head of claim 17 further comprising a control system in communication with said first transducer and said second transducer for generating correction signals and having an output for connection to means for adjusting said TV/video camera, mounting for said TV/video camera, optics for said TV/video camera, image capture, image replay or post image processing for applying corrections thereto for said unwanted movement.

19. The pan and tilt head of claim 15 wherein the optical apparatus comprises a light beam directing device or a sighting device.

20. The pan and tilt head of claim 19 further comprising a control system in communication with said first transducer and said second transducer for generating correction signals and having an output for communication with an adjustable feature of the apparatus to correct the said unwanted movement.
